(19) United States
(12) Patent Application Publication
(10) Pub. No.: US 2018/0253062 A1
(43) Pub. Date: Sep. 6, 2018

(54) CLOCKING DEVICE, IMAGE FORMING APPARATUS, AND TIME POINT CORRECTION METHOD

(71) Applicants: KABUSHIKI KAISHA TOSHIBA, Tokyo (JP); TOSHIBA TEC KABUSHIKI KAISHA, Tokyo (JP)

(72) Inventor: Satoshi Yuruzume, Sunto Shizuoka (JP)

(21) Appl. No.: 15/447,512

(22) Filed: Mar. 2, 2017

(51) Int. Cl. G04D 7/00; G04F 10/04; H04N 1/00

(52) U.S. Cl. CPC G04D 7/003; G04F 10/04; H04N 2201/0094; H04N 1/00087; H04N 1/00933; H04N 1/00068

(57) ABSTRACT

There is provided a clocking device including: a clocking unit configured to count the number of clocks of a signal output from an oscillation circuit to clock a time point; a communication unit configured to receive pieces of time point information respectively from a plurality of mobile terminals; a processing unit configured to calculate a correction time of the clocking unit on the basis of time points respectively indicated by the time point information received by the communication unit and the time point clocked by the clocking unit; and a correction unit configured to correct the time point of the clocking unit on the basis of the correction time.

### FIELD

Embodiments described herein relate generally to a clocking device, an image forming apparatus, and a time point correction method.

### BACKGROUND

A facsimile, a printer, or a multifunction peripheral (MPF) has a function of printing a time point. A device such as an MPF having such a function is therein provided with a real time clock (RTC) circuit that clocks a time point. In clocking using the RTC circuit, clocking based on clocks output by a quartz oscillator is performed. As a result, an error between the clocked time point and a standard time point increases over time.

In the related art, correction of a time point has been performed using a time point acquired from a network time protocol (NTP) server. By using such a technique, correct time can be clocked even though the accuracy of the RTC circuit is low to a certain extent. Thus, inexpensive components can be used in the RTC circuit.

However, when the device such as the MPF cannot be connected to the NTP server or the like, or is provided under an environment where the connection is not easy, it is difficult to sufficiently perform the time point correction based on the standard time point. In such a case, in order to clock the correct time point, it is necessary to enhance the accuracy of the RTC circuit, which leads to an increase in the manufacturing cost of the device.

### DESCRIPTION OF THE DRAWINGS

FIG. 1 is a diagram showing an image forming apparatus according to Embodiment 1.

FIG. 2 is a configuration diagram of a clocking device according to Embodiment 1.

FIG. 3 is a configuration diagram of a communication unit according to Embodiment 1.

FIG. 4 is a configuration diagram of the clocking device according to Embodiment 1.

FIG. 5 is a configuration diagram of a statistical processing unit according to Embodiment 1.

FIG. 6 is a diagram illustrating a statistical process according to Embodiment 1.

FIG. 7 is a flowchart illustrating a clocking process of the clocking device according to Embodiment 1.

FIG. 8 is a flowchart illustrating a clocking process based on a mobile terminal of the clocking device according to Embodiment 1.

FIG. 9 is a flowchart illustrating a statistical process of the clocking device according to Embodiment 1.

FIG. 10 is a flowchart illustrating a clocking process of a clocking device according to Embodiment 2.

FIG. 11 is a diagram illustrating a statistical process according to a modification example.

### DETAILED DESCRIPTION

An image forming apparatus 1 according to embodiments described herein includes a clocking device 100 that clocks a correct time point by correcting a time point based on time point information received from a plurality of mobile terminals 200. Hereinafter, the image forming apparatus 1 according to the embodiments described herein will be described with reference to the accompanying drawings.

### Embodiment 1

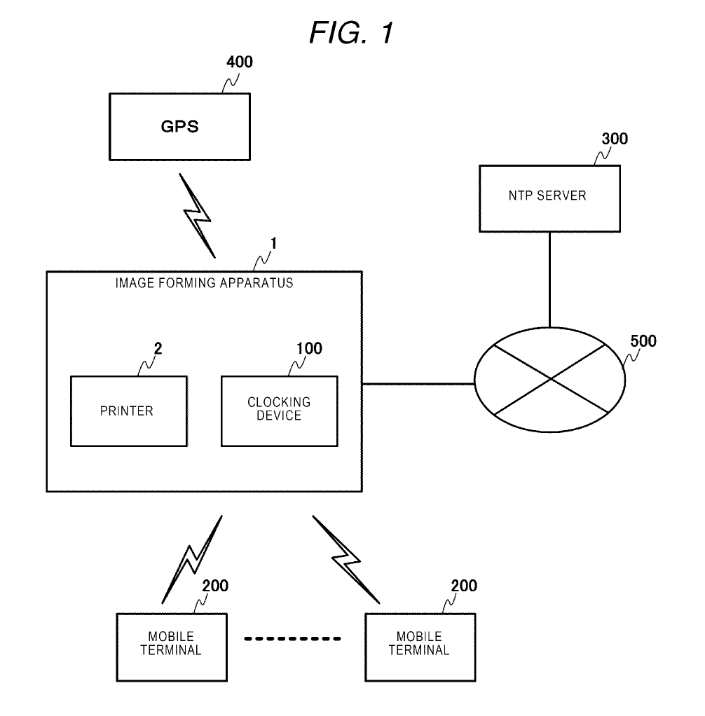

FIG. 1 is a diagram showing an image forming apparatus according to Embodiment 1. The image forming apparatus 1 is an MFP having a printing function or a FAX transmission and reception function. The image forming apparatus 1 prints an image based on acquired information, and in addition, prints a printing time point when printing is executed. The image forming apparatus 1 includes a printer 2 and the clocking device 100.

The printer 2 prints a time point indicated by time point information supplied from the clocking device 100 in printing on a header, a footer, or the like of a sheet which is a printing target. As the printer 2, a printing unit such as a laser printer or an ink jet printer may be used.

The clocking device 100 is a device for clocking a time point. If the clocking device 100 is connected to an NTP server 300 through a network 500, the clocking device 100 corrects a time point of the device based on a time point indicated by time point information acquired from the NTP server 300 at a predetermined timing. Further, the clocking device 100 has a communication function. Thus, if the clocking device 100 is able to communicate with a global positioning system (GPS) 400, the clocking device 100 corrects a time point of the device based on a time point indicated by time point information acquired from the GPS at a predetermined timing.

If the clocking device 100 is not able to acquire the time point information from the NTP server 300 and the GPS 400, the clocking device 100 corrects a time point of the device based on a time point indicated by time point information acquired from the mobile terminal 200. Hereinafter, the clocking device 100 will be described in detail.

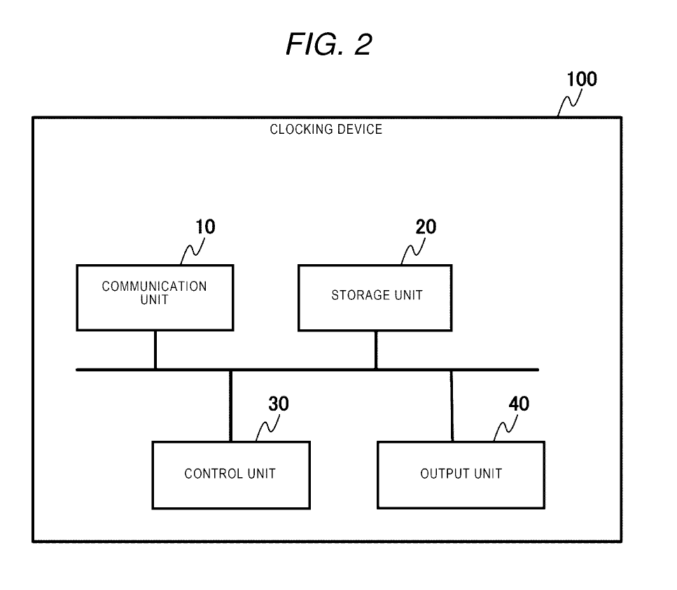

The clocking device 100 physically includes a communication unit 10, a storage unit 20, a control unit 30, and an output unit 40, as shown in FIG. 2.

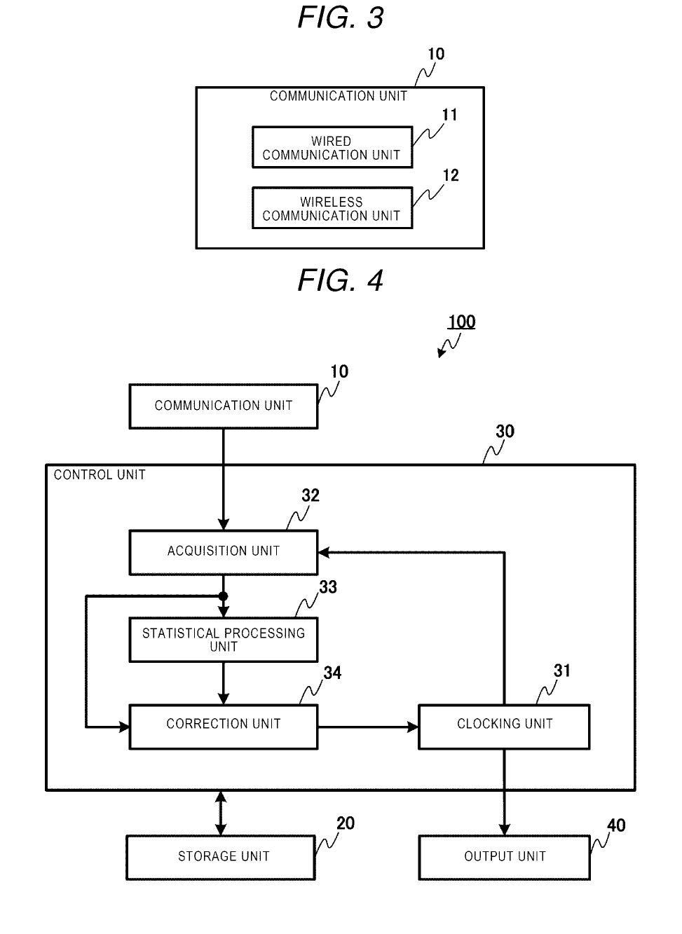

The communication unit 10 includes a wired communication unit 11 and a wireless communication unit 12, as shown in FIG. 3. The wired communication unit 11 is configured by an optical communication module, a modem, and the like. The wired communication unit 11 communicates with the NTP server 300 through the network 500, and receives time point information from the NTP server 300.

The wireless communication unit 12 is configured by a wireless communication module, a modem, and the like. The wireless communication module includes a mobile phone wireless module, a GPS module, a wireless local area network (LAN) module, a Bluetooth (registered trademark) wireless module, or the like. The wireless communication unit 12 communicates with the mobile terminal 200 and the GPS 400 to acquire time point information.

The mobile terminal 200 which is a communication target of the wireless communication unit 12 is a terminal in which an application for communicating with the image forming apparatus 1 is installed in advance and the application is executed. As the application is executed, the mobile terminal 200 is able to transmit and receive information between the wireless communication unit 12 and the mobile terminal 200. The information transmitted from the mobile terminal 200 includes, for example, time point information indicating a time point clocked by the mobile terminal 200 or identification information for identifying the terminal. A smartphone, a tablet, or the like may be considered as the mobile terminal 200.

The communication unit 10 communicates with the NTP server 300, the GPS 400, and the mobile terminal 200 at a predetermined timing, performs a transmission request of time point information indicating the standard time point, and receives the transmitted time point information. The predetermined timing refers to a timing which is set in advance in a program, for example, a timing when power is supplied, every minute, every hour, every day, or every 1 month.

Returning to FIG. 2, the storage unit 20 is configured by a read only memory (ROM), and a random access memory (RAM). The ROM stores in advance a program to be executed by a CPU of the control unit 30, necessary data when the program is executed, or the like. The RAM stores data created or changed while the program is being executed.

The control unit 30 is physically configured by a central processing unit (CPU), or the like, and realizes the following functions by executing the program of the clocking device 100 stored in the storage unit 20.

The control unit 30 functionally includes a clocking unit 31, an acquisition unit 32, a statistical processing unit 33, and a correction unit 34, as shown in FIG. 4.

The clocking unit 31 includes an RTC circuit configured by a crystal oscillation circuit, a counter circuit, and the like. The RTC circuit counts the number of clocks of a signal output from the crystal oscillation circuit using the counter circuit, to thereby measure elapsed time. Accordingly, an error between a time point indicated by the RTC circuit and the standard time point becomes larger over time due to an accuracy error of the crystal oscillation circuit which is provided therein. If a high accuracy RTC circuit is used, the device cost increases. Thus, the RTC circuit is configured by relatively inexpensive components on the premise that it is periodically corrected on the basis of the standard time point.

The acquisition unit 32 acquires time point information from the communication unit 10, and calculates time difference data indicating the error between a time point clocked by the clocking unit 31 and the standard time point. When calculating time difference data based on time point information acquired from the NTP server 300 or the GPS 400, the acquisition unit 32 supplies the time difference data to the correction unit 34. Further, when calculating time difference data based on time point information acquired from each of the mobile terminals 200, the acquisition unit 32 supplies the time difference data and an identification (ID) number which is identification information for specifying each of the mobile terminals 200 to the statistical processing unit 33.

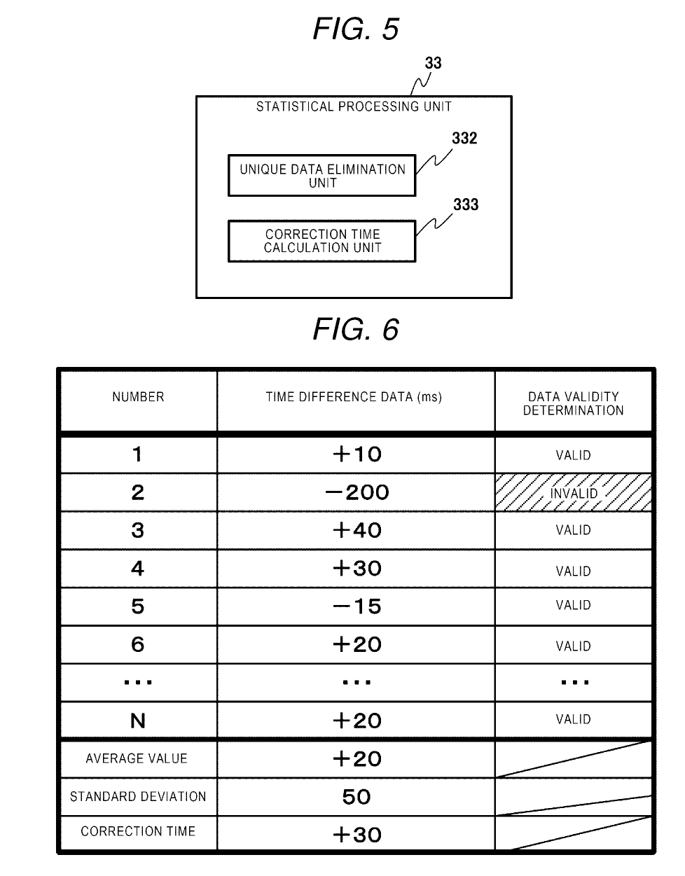

The statistical processing unit 33 statistically processes the time difference data acquired from the mobile terminal 200 to calculate a correction time for correcting the time point of the clocking unit 31. The statistical processing unit 33 includes a unique data elimination unit 332 and a correction time calculation unit 333, as shown in FIG. 5.

Generally, the mobile terminal 200 periodically receives time point information from the NTP server 300 or the like through a telephone communication network or the Internet. Further, the mobile terminal 200 corrects a time point of a timepiece which is provided therein. For this reason, it is considered that the time point of the mobile terminal 200 is approximately the same as the standard time point. However, there is a case where time point information indicating a time point that is distant from the standard time point is mixed in time point information received from the plurality of mobile terminals 200. If a statistical process is performed in consideration of such time point information with low reliability, the reliability of the correction time to be calculated is also lowered. In order to prevent such a problem, the clocking device 100 includes the unique data elimination unit 332.

The unique data elimination unit 332 calculates an average value and a standard deviation of the time difference data supplied from the acquisition unit 32. Further, the unique data elimination unit 332 eliminates time difference data which is distant from the average value by a value of the standard deviation or larger as unique data, for example.

The correction time calculation unit 333 calculates an average value of the time difference data after the unique data is eliminated, and sets the average value as the correction time. The unique data elimination unit 332 stores ID numbers associated with the eliminated time difference data in the storage unit 20.

A specific example will be described with reference to FIG. 6. Here, it is assumed that N pieces of time difference data are supplied from the mobile terminals 200. The unique data elimination unit 332 calculates an average value and a standard deviation of the N pieces of time difference data. In the example shown in FIG. 6, the calculated average value is +20 ms, and the standard deviation is 50 ms. The unique data elimination unit 332 eliminates time difference data of −30 ms or smaller or +70 ms or larger, distant from the average value +20 ms by the standard deviation 50 ms or larger, as unique data. In validity determination columns of data shown in FIG. 6, data written as “invalid” is the unique data.

The correction time calculation unit 333 calculates an average value of the remaining time difference data obtained by eliminating the unique data from the N pieces of time difference data. In the example shown in FIG. 6, the average value is +30 ms. The correction time calculation unit 333 calculates the average value as a correction time.

Returning to FIG. 4, with respect to time difference data based on time point information acquired from the NTP server 300 or the GPS, the correction unit 34 sets a value obtained by adding a processing time to the time difference data as a correction time, and corrects a time point of the clocking unit 31. The processing time refers to a transmission processing time of the mobile terminal 200, a propagation time of radio waves from the mobile terminal 200 to the clocking device 100, and a processing time in the clocking device 100 taken from the time when time point information is received to the time when the clocking unit 31 is corrected. Further, with respect to time difference data based on time point information acquired from the mobile terminal 200, the correction unit 34 sets a value obtained by adding the processing time to a correction time calculated by the statistical processing unit 33 as a correction time, and corrects the time point of the clocking unit 31.

The output unit 40 supplies the time point clocked by the clocking unit 31 to the printer 2.

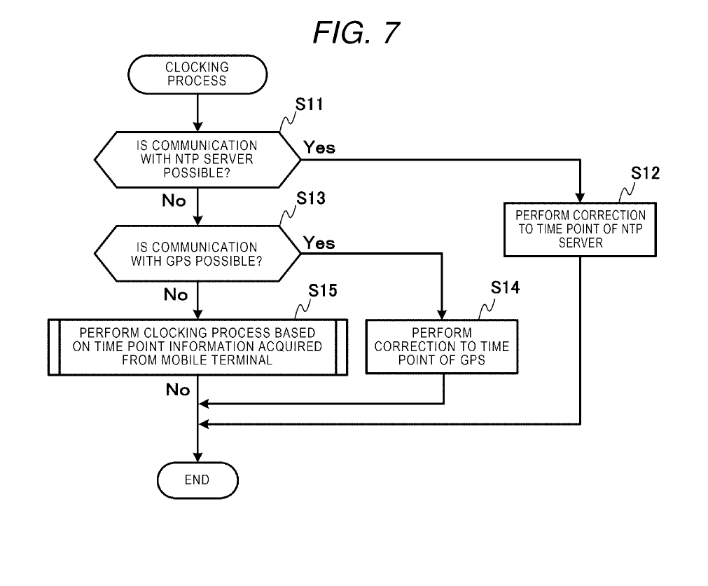

Next, a clocking process of the clocking device 100 having the above-described configuration will be described with reference to FIGS. 7 to 9. If a user supplies power to the image forming apparatus 1 and a CPU starts up a program stored in the ROM, a clocking process shown in FIG. 7 starts at a predetermined timing. The predetermined timing refers to a timing which is set in advance, for example, a timing when power is supplied, every minute, every hour, every day, or every 1 month. Further, it is assumed that a time Tw for waiting for time point information transmitted from the mobile terminal 200 (which will be described later) is set in advance in the program. The time Tw is set to 1 minute, for example.

If the clocking process starts, the control unit 30 determines whether it is possible to communicate with the NTP server 300 through the communication unit 10 (Act 11). If it is possible to communicate with the NTP server 300 (Act 11: Yes), the acquisition unit 32 calculates time difference data indicating a difference between a time point indicated by the time point information acquired from the NTP server 300 and the time point clocked by the clocking unit 31. In addition, the acquisition unit 32 supplies the calculated time difference data to the correction unit 34. The correction unit 34 sets time obtained by adding the processing time to the time difference data based on the time point information acquired from the NTP server 300 as a correction time, and corrects the time point of the clocking unit 31 (Act 12).

If it is not possible to communicate with the NTP server 300 (Act 11: No), the control unit 30 determines whether it is possible to communicate with the GPS 400 through the communication unit 10 (Act 13). If it is possible to communicate with the GPS (Act 13: Yes), the acquisition unit 32 calculates time difference data indicating a difference between a time point indicated by the time point information acquired from the GPS 400 and the time point clocked by the clocking unit 31. Then, the acquisition unit 32 supplies the time difference data to the correction unit 34. The correction unit 34 sets time obtained by adding the processing time to the time difference data based on the time point information acquired from the GPS 400 as a correction time, and corrects the time point of the clocking unit 31 (Act 14).

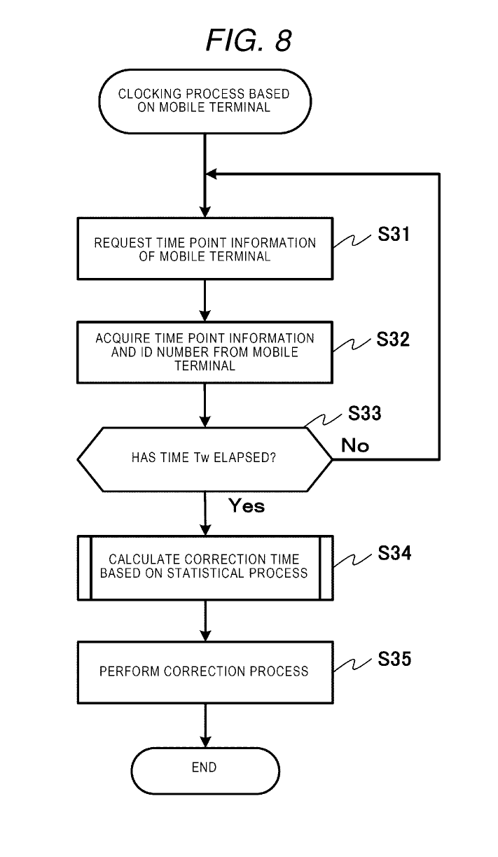

If it is not possible to communicate with the GPS 400 (Act 13: No), the control unit 30 performs the clocking process based on the time point information acquired from the mobile terminal 200 (Act 15). The clocking process based on the time point information acquired from the mobile terminal 200 will be described with reference to FIG. 8.

If the clocking process based on the time point information acquired from the mobile terminal 200 starts, the control unit 30 requests transmission of the time point information of the mobile terminal 200 through the communication unit 10 (Act 31). The mobile terminal 200 that receives the transmission request of the time point information transmits the time point information indicating the time point clocked by the mobile terminal 200 and an ID number for specifying the mobile terminal 200 to the clocking device 100. Then, the acquisition unit 32 acquires the time point information and the ID number for specifying the mobile terminal 200 from the mobile terminal 200 (Act 32). The acquisition unit calculates time difference data between the time point information acquired from the mobile terminal 200 and the time point information clocked by the clocking unit 31. Furthermore, the acquisition unit 32 stores the time difference data in the storage unit 20 in association with the ID number.

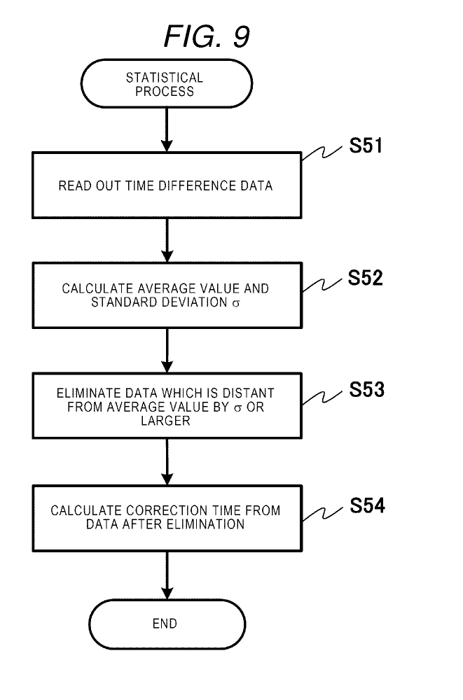

The control unit 30 determines whether the predetermined waiting time Tw has elapsed (Act 33). If the waiting time Tw has not elapsed (Act 33: No), the control unit 30 returns to Act 31 and continues the processes from Act 31 to Act 33. If the waiting time Tw has elapsed (Act 33: Yes), the statistical processing unit 33 reads out the time difference data from the storage unit 20, and statistically processes the time difference data to calculate a correction time for correcting the time point clocked by the clocking unit 31 (Act 34). The statistical process will be described with reference to FIG. 9.

If the statistical process starts, the unique data elimination unit 332 reads out time difference data associated with an ID number which is registered in advance from the storage unit 20 (Act 51).

Then, the unique data elimination unit 332 calculates an average value and a standard deviation σ of the time difference data read out from the storage unit 20 (Act 52). Further, the unique data elimination unit 332 eliminates time difference data which is distant from the average value by the standard deviation σ or larger as unique data (Act 53). The correction time calculation unit 333 calculates an average value of the time difference data after the unique data is eliminated as a correction time (Act 54). If the process of Act 54 is terminated, the process based on the control unit 30 transitions to Act 35 in FIG. 8.

The correction unit 34 sets time obtained by adding the processing time to the correction time calculated by the statistical processing unit 33 as a correction time, and corrects the time point of the clocking unit 31 (Act 35). If the process of Act 35 is terminated, the process of Act 15 shown in FIG. 7 is terminated, and then, the clocking process based on the clocking device 100 is terminated.

As described above, the clocking device 100 includes the communication unit 10 that receives time point information from a plurality of terminals, the statistical processing unit 33 that statistically processes time difference data between time point information received by the communication unit 10 and time point clocked by the clocking unit 31 and calculates a correction time of the clocking unit 31, and the correction unit 34 that corrects the time point of the clocking unit 31 based on the correction time. With this configuration, the clocking device 100 can correctly correct the time point of the clocking device 100, even when the clocking device 100 is provided under an environment where time point information indicating the standard time point cannot be acquired through a network or the like.

The statistical processing unit 33 sets an average value of time difference data between the time point information and the time point clocked by the clocking unit 31 as a correction time, and the correction unit 34 corrects the time point of the clocking unit 31 based on the correction time. With this configuration, the clocking device 100 can correctly correct the time point of the clocking device 100, even when the clocking device 100 is provided under an environment where time point information indicating the standard time point cannot be acquired through a network or the like.

The statistical processing unit 33 extracts unique data from the time difference data between the time point information and the time point clocked by the clocking unit 31, and eliminates the unique data from the time difference data to calculate an average value. Thus, the clocking device 100 can more correctly correct the time point of the device.

### Embodiment 2

Next, Embodiment 2 will be described. An image forming apparatus 1 according to Embodiment 2 is different from the image forming apparatus according to Embodiment 1 in that a remote control using the mobile terminal 200 is possible. Hereinafter, the image forming apparatus 1 according to Embodiment 2 will be described. The same reference numerals are used for the same or equivalent configurations as in Embodiment 1, and description thereof will be omitted or simplified.

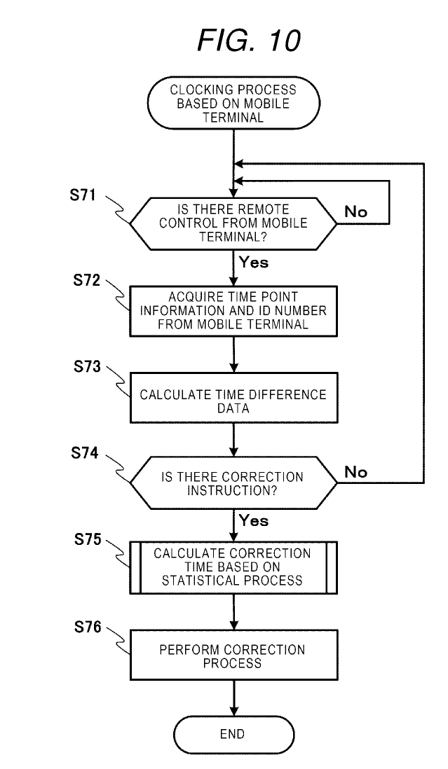

If the remote control from the mobile terminal 200 is made, the image forming apparatus 1 acquires time point information from the mobile terminal 200, and calculates a correction time of the clocking unit 31. Hereinafter, a clocking process will be described with reference to FIG. 10.

If a user supplies power to the image forming apparatus 1 and a CPU starts up a program stored in a ROM, a clocking process based on the mobile terminal shown in FIG. 10 starts.

If the remote control of the image forming apparatus 1 using the mobile terminal 200 is made by the user, the mobile terminal 200 transmits information including an ID number for specifying the mobile terminal 200, operation content of the remote control, and a transmission time point to the image forming apparatus 1.

The control unit 30 continuously monitors whether the remote control from the mobile terminal 200 is present (Act 71: No). If the remote control from the mobile terminal 200 is present (Act 71: Yes), the acquisition unit 32 acquires time point information and an ID number for specifying the mobile terminal 200 through the communication unit 10 (Act 72). Further, the acquisition unit 32 calculates time difference data between a time point indicated by the time point information acquired from the mobile terminal 200 and a time point clocked by the clocking unit 31 (Act 73). The acquisition unit 32 stores the time difference data and the ID number in the storage unit 20 in association. The time difference data shown in FIG. 6 is accumulated in the storage unit 20.

The control unit 30 determines the presence or absence of a correction instruction based on a timing set in a program in advance (Act 74). If the correction instruction is not present (Act 74: No), the procedure returns to Act 71, and the control unit 30 continues the processes from Act 71 to Act 74.

If the predetermined timing arrives and the correction instruction is present (Act 74: Yes), the statistical processing unit 33 performs a statistical process to calculate a correction time (Act 75). Then, the correction unit 34 sets a time obtained by adding the processing time to the correction time calculated by the statistical processing unit 33 as a correction time, and corrects the time point clocked by the clocking unit 31 (Act 76). The process of Act 75 is the same as the process of Act 34 in Embodiment 1. Further, the process of Act 76 is the same as the process of Act 35 in Embodiment 1.

As described above, if the remote control based on the mobile terminal 200 is performed, the clocking device 100 corrects the time point clocked by the clocking unit 31 based on the time point information received from the mobile terminal 200. With this configuration, the clocking device 100 can correctly correct the time point of the clocking device 100, even when the clocking device 100 is provided under an environment where time point information indicating the standard time point cannot be acquired through a network or the like.

Hereinbefore, the embodiments of the present disclosure have been described, but the present disclosure is not limited to the embodiments. For example, in the above-described embodiments, a configuration in which the communication unit 10 is provided in the clocking device 100 is shown. The present disclosure is not limited thereto, and the communication unit 10 may be an external device that is provided separately from the clocking device 100. For example, the communication unit 10 may be provided as a communication device which is separately mounted in the image forming apparatus 1, and the acquisition unit 32 of the clocking device 100 may acquire data through the communication device.

In the above-described embodiments, a configuration in which the clocking device 100 has a function of acquiring time point information from the NTP server 300 and the GPS 400 is shown. The present disclosure is not limited thereto, and the clocking device 100 may not have a function of communicating with the NTP server 300 or the GPS 400.

In the above-described embodiments, a configuration in which the clocking device 100 includes the unique data elimination unit 332 is shown. However, the present disclosure is not limited thereto, and the clocking device 100 may not include the unique data elimination unit 332.

The mobile terminal 200 may include a smartphone, a tablet terminal, a mobile phone set, or the like.

### Modification Example 1

In the description of Embodiment 1, referring to FIG. 7, a configuration in which the waiting time Tw is set and the statistical process is performed on the basis of time point information acquired for the waiting time Tw has been described. However, the conditions for acquiring time point information from the mobile terminal 200 are not limited thereto. For example, a condition may be set such that the waiting time Tw is not set, and instead, a predetermined number N of (for example, 100) pieces of time point information are received. In this case, the process of Act 33 in FIG. 7 may be changed to a process of confirming whether the N pieces of time point information is acquired.

### Modification Example 2

In the description of Embodiment 1, a configuration in which the statistical processing unit 33 calculates time difference data between a time point indicated by time point information acquired from the mobile terminal 200 and a time point clocked by the clocking unit 31 and calculates an average value of the time difference data as a correction time is shown. However, a method for calculating the correction time is not limited thereto.

For example, the correction time may be calculated on the basis of a frequency distribution of the time difference data, instead of the average value of the time difference data. Hereinafter, a clocking device 100 according to Modification example 2 will be described.

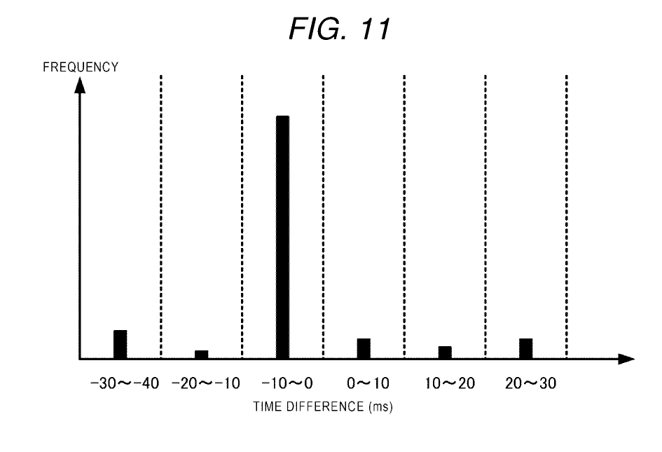

The statistical processing unit 33 of the clocking device 100 divides time difference data acquired from the acquisition unit 32 into groups specified according to the size of a time difference, and adds up time difference data in each group. FIG. 11 is a diagram showing a time difference and a frequency, in which a lateral axis represents the time difference and a longitudinal axis represents the frequency. As shown in FIG. 11, for example, when the level of accuracy of a correction time is set to 10 ms, the statistical processing unit 33 specifies a plurality of different groups having different ranges each of which is set to 10 ms so that the ranges are set to −40 to −30, −30 to −20, and so on, for example. Further, time difference data that belongs to each group is grouped to be added up.

Among the mobile terminals 200, there are a model which is temporally synchronized with the NTP server 300 or the GPS 400 and a model which is not temporally synchronized therewith. Time point information acquired from the mobile terminal 200 which is not temporally synchronized with the NTP server 300 or the GPS 400 is based on the accuracy of a crystal oscillator mounted in each mobile terminal 200. Accordingly, it is expected that the time difference data is randomly distributed in the respective groups. On the other hand, the entirety of time point information acquired from the mobile terminal 200 which is temporally synchronized with the NTP server 300 or the GPS 400 is based on a time point of the NTP server 300. Accordingly, it is expected that the time difference data also have the same value and is distributed in a specific group. As a result, as shown in FIG. 11, only the frequency of acquisition of time difference data that belongs to a certain time difference group has a large value.

In the case shown in FIG. 11, the statistical processing unit 33 calculates −5 ms which is a central value of a range (−10 ms to 0) indicated by a group having the highest frequency as a correction time. The correction unit 34 sets a value obtained by adding the processing time to the correction time (−5 ms) calculated by the statistical processing unit 33 as a correction time, and corrects a time point of the clocking unit 31.

The statistical processing unit 33 calculates a time difference data frequency for each group indicating a predetermined time difference, and sets a time indicated by a group of a time difference having the highest frequency as a correction time. Thus, the clocking device 100 can be temporally synchronized with the NTP server 300 or the GPS 400 in an indirect manner, and can correctly correct a time point of the clocking device 100.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A clocking device comprising:
a clocking unit configured to count the number of clocks of a signal output from an oscillation circuit to clock a time point;
a communication unit configured to receive pieces of time point information respectively from a plurality of mobile terminals;
a processor configured to calculate a correction time of the clocking unit on the basis of time points respectively indicated by the time point information received by the communication unit and the time point clocked by the clocking unit; and
a correction unit configured to correct the time point of the clocking unit on a basis of the correction time.

2. The device according to claim 1,
wherein the processor sets an average value of differences between the time points respectively indicated by the time point information and the time point clocked by the clocking unit as the correction time.

3. The device according to claim 2,
wherein the processor eliminates unique information from the time point information on the basis of the differences between the time points respectively indicated by the time point information and the time point clocked by the clocking unit to calculate the average value.

4. The device according to claim 3,
wherein the processor calculates a standard deviation of the differences between the time points respectively indicated by the time point information and the time point clocked by the clocking unit, and determines the unique information on the basis of the standard deviation.

5. The device according to claim 1,
wherein the processor specifies a plurality of groups on the basis of an error range of time points, groups differences between the time points respectively indicated by the time point information and the time point clocked by the clocking unit into any one of the plurality of groups, and sets an error indicated by a group having the largest number of grouped differences as the correction time.

6. The device according to claim 1, further comprising:
an unique data elimination unit configured to calculate an average value and a standard deviation of time difference data.

7. The device according to claim 1,
wherein the communication unit comprises a wired communication unit and a wireless communication unit.

8. The device according to claim 1,
wherein the oscillation circuit comprises a crystal oscillation circuit.

9. An image forming apparatus comprising:
the clocking device according to claim 1; and
an image forming unit configured to form an image on a recording medium.

10. The image forming apparatus according to claim 9,
wherein the image forming apparatus is a multifunction peripheral.

11. The image forming apparatus according to claim 9,
wherein the image forming apparatus is a facsimile.

12. The image forming apparatus according to claim 9,
wherein the image forming apparatus is a laser printer.

13. The image forming apparatus according to claim 9,
wherein the image forming apparatus is an inkjet printer.

14. A time point correction method comprising:
counting a number of clocks of a signal output from an oscillation circuit to clock a time point;
respectively acquiring time point information from a plurality of mobile terminals;
calculating a correction time on a basis of time points respectively indicated by the time point information and the clocked time point; and
correcting the time point on the basis of the correction time.

15. The method according to claim 14,
wherein in the calculating of the correction time, an average value of differences between the time points respectively indicated by the time point information and the clocked time point is calculated as the correction time.

16. The method according to claim 15,
wherein in the calculating of the correction time, unique information is eliminated from the time point information on the basis of the differences between the time points respectively indicated by the time point information and the clocked time point to calculate the average value.

17. The method according to claim 16,
wherein in the calculating of the correction time, a standard deviation of the differences between the time points respectively indicated by the time point information and the clocked time point is calculated, and the unique information is determined on the basis of the standard deviation.

18. The method according to claim 17,
wherein in the calculating of the correction time, a plurality of groups are specified on the basis of an error range of time points, the differences between the time points respectively indicated by the time point information and the clocked time point are grouped into any one of the plurality of groups, and an error indicated by a group having the largest number of grouped differences is set as the correction time.

19. The method according to claim 14, further comprising:
calculating an average value and a standard deviation of time difference data.

20. The method according to claim 14,
wherein the oscillation circuit comprises a crystal oscillation circuit.
